(19) United States
(12) Patent Application Publication
(10) Pub. No.: US 2023/0229460 A1
(43) Pub. Date: Jul. 20, 2023

(54) METHOD AND APPARATUS FOR IDENTIFYING DYNAMICALLY INVOKED COMPUTER CODE

(71) Applicant: WHITESOURCE LTD., Givatayim (IL)

(72) Inventors: Aharon ABADI, Givatayim (IL); Ron SHEMER, Givatayim (IL)

(21) Appl. No.: 17/577,328

(22) Filed: Jan. 17, 2022

(51) Int. Cl. G06F 9/445; G06F 8/41; G06F 9/54; G06F 21/56; G06F 21/57

(52) U.S. Cl. CPC G06F 9/44521; G06F 8/433; G06F 9/547; G06F 21/563; G06F 21/577

(57) ABSTRACT

A method, computerized apparatus and computer program product, the method comprising: obtaining user code; using static analysis, determining from the user code a collection of components upon which the user code depends, the collection of components comprising a first component representing a first entity, wherein one or more components of the collection of components is to be loaded dynamically by the user code; determining whether the user code or the first component from the collection of components uses dynamic invocation; subject to the user code or the first component using dynamic invocation, adding a new connection to a second component from the collection of components, the second component representing a second entity that augments an entity reachable from the first entity; and outputting information about the second entity.

### TECHNICAL FIELD

The present disclosure relates to identifying dynamically invoked computer code in general, and to a method and apparatus for statically detecting vulnerability in dynamically loaded code, in particular.

### BACKGROUND

Software vulnerabilities are a major cause of a variety of problems, including security problems, privacy violations, financial risks, or any other trouble ranging between mere inconvenience and critical interests including life and death. In particular, security vulnerabilities open a gate to computer hacks, which may cause tremendous damage to the computers and/or to users and clients of the computer systems. By taking advantage of design or implementation flaws, malicious attackers are able to gain access to confidential information available to the target program, take control of the data and use it in a problematic manner. A straight forward example relates to a buffer overflow which can be exploited by attackers to manipulate the software input, overwrite the stack and thus gain control over areas of the code and affect execution of the program.

Some methodologies exist for detecting vulnerabilities, wherein one important distinction is between static and dynamic methods.

Static program analysis is the analysis of computer software performed without executing the program, by only analyzing the computer instructions. Static analysis may refer to the source code or to the object code. Static program analysis sometime uses software metrics and reverse engineering. However, using static analysis does not always enable to determine the dynamic behavior of the code, and in particular when it is unknown which code actually gets executed.

Dynamic analysis, in contrast, may be performed on programs while they are executing. This inherently implies that vulnerability discovery is limited by the coverage of the program, may require a large number of scenarios to be run, but even that cannot guarantee that all vulnerabilities have been discovered.

Yet, with both approaches, debugging code to discover vulnerabilities is a hard task and is an everlasting struggle during the entire development and life cycle of the code.

### BRIEF SUMMARY

One exemplary embodiment of the disclosed subject matter is a computer-implemented method comprising: obtaining user code; using static analysis, determining from the user code a collection of components upon which the user code depends, the collection of components comprising a first component representing a first entity, wherein one or more components of the collection of components is to be loaded dynamically by the user code; determining whether the user code or the first component from the collection of components uses dynamic invocation; subject to the user code or the first component using dynamic invocation, adding a new connection to a second component from the collection of components, the second component representing a second entity that augments an entity reachable from the first entity; and outputting information about the second entity. Within the method, the new connection is optionally between the user code and the second component. Within the method, the new connection is optionally between the first component and the second component. Within the method, adding the new connection optionally comprises: detecting within the user code or the first component a reflection-related instruction that invokes dynamically an augmentation of the first entity; identifying the second entity that augments the first entity; adding the second component representing the second entity to the collection of components; and adding a connection between the user code or the first component and the second component. Within the method, detecting the reflection-related instruction optionally comprises identifying instructions related to a reflection Abstract Program Interface (API). Within the method, the instructions optionally comprise: an instruction for importing a reflection library; and an instruction for calling a method or component from the reflection library for dynamically loading a component. The method can further comprise: using information retrieved from a database, determining that one or more stored vulnerabilities are reachable from the second entity, thereby identifying a potential vulnerability reachable from the user code. The method can further comprise outputting the vulnerabilities. Within the method, the collection of components and connections optionally forms a dependency graph. Within the method, at least one component from the collection of components optionally represents a class, a file, a method, a function, a program component, an interface, or a module. Within the method, a component from the collection of components is optionally to be dynamically loaded for interrogating an entity in run time for getting properties of the entity. Within the method, the second entity augmenting the first entity optionally relates to the first entity being an interface and the second entity being an implementation of the interface, wherein the connection connects the component comprising the interface to the component comprising the implementation the interface. Within the method, the second entity augmenting the first entity optionally relates to the first entity being a class and the second entity being an extension of the class, and the connection connects the component comprising the extension of the class to the component comprising the class.

Another exemplary embodiment of the disclosed subject matter is a computerized apparatus having a processor, the processor being adapted to perform the steps of: obtaining user code; using static analysis, determining from the user code a collection of components upon which the user code depends, the collection of components comprising a first component representing a first entity, wherein one or more components of the collection of components is to be loaded dynamically by the user code; determining whether the user code or the first component from the collection of components uses dynamic invocation; subject to the user code or the first component using dynamic invocation, adding a new connection to a second component from the collection of components, the second component representing a second entity that augments an entity reachable from the first entity; and outputting information about the second entity. Within the apparatus, the new connection is optionally between the user code and the second component or between the first component and the second component. Within the apparatus, adding the new connection optionally comprises: detecting within the user code or the first component a reflection-related instruction that invokes dynamically an augmentation of the first entity; identifying the second entity that augments the first entity; adding the second component representing the second entity to the collection of components; and adding a connection between the user code or the first component and the second component. Within the apparatus, detecting the reflection-related instruction optionally comprises identifying instructions, wherein the instructions comprise: an instruction for importing a reflection library; and an instruction for calling a method or component from the reflection library for dynamically loading a component. Within the apparatus, the tsps. Optionally further comprise: using information retrieved from a database, determining that at least one stored vulnerability is reachable from the second entity, thereby identifying a potential vulnerability reachable from the user code; and outputting the at least one stored vulnerability. Within the apparatus, the component of the collection of components is optionally to be dynamically loaded for interrogating an entity in run time for getting properties of the entity.

Yet another exemplary embodiment of the disclosed subject matter is a computer program product comprising a computer readable storage medium retaining program instructions, which program instructions when read by a processor, cause the processor to perform a method comprising: obtaining user code; using static analysis, determining from the user code a collection of components upon which the user code depends, the collection of components comprising a first component representing a first entity, wherein one or more components of the collection of components is to be loaded dynamically by the user code; determining whether the user code or the first component from the collection of components uses dynamic invocation; subject to the user code or the first component using dynamic invocation, adding a new connection to a second component from the collection of components, the second component representing a second entity that augments an entity reachable from the first entity; and outputting information about the second entity.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows a class diagram of code containing a reflection API;

FIG. 1B shows a traditional dependency graph that corresponds to the situation of FIG. 1A;

FIG. 1C shows a dependency graph created, in accordance with some embodiments of the disclosure;

FIG. 2 shows a flowchart of steps in a method statically generating a dependency graph including dynamically invoked code, in accordance with some exemplary embodiments of the subject matter; and

FIG. 3 is a block diagram of a system for statically generating a dependency graph including dynamically invoked code, in accordance with some exemplary embodiments of the disclosure.

### DETAILED DESCRIPTION

A dependency graph is a data structure representing the dependency relationship between methods, functions or other code units within computer code such as a programming project, wherein execution of one unit depends on another unit. In some embodiments, each node or vertex in a dependency graph represents such unit, and an edge from node A to node B represents that the unit represented by node A is dependent on the unit represented by node B.

A call graph is a particular type of dependency graph, which represents the invocation relationship between code units. In some embodiments, an edge from node A to node B represents that the unit represented by node A invokes the unit represented by node B.

One technical problem dealt with by the disclosed subject matter relates to discovering vulnerabilities in software code. The problem becomes harder as the software becomes larger and more distributed among various libraries. A human trying to analyze such code and discover vulnerabilities therein cannot possibly thoroughly analyze the complex call chains of methods.

Code reachability analysis can be utilized to detect reachable code components, and if any such code component contains vulnerabilities, it may pose danger. Often, the code may be represented as a dependency graph comprising a collection of nodes and edges, wherein each node represents a code unit, and a directed edge from node f to node g indicates that unit f is dependent upon unit g. Reachable code is identified as a node wherein a path exists from the root of the graph, e.g. a starting point of a program, to the node.

However, using current technologies, static analysis cannot take into account files, libraries or other components that are loaded dynamically (i.e., at runtime, when the program is executed), since it may not be known prior to runtime which units will be invoked. Moreover, the invoked units may change between different executions. Thus, such dynamically loaded components are not being analyzed, and vulnerabilities that may be contained in these entities or in further entities called by them, and are reachable from the analyzed program, may go undetected.

Dynamic loading of units in runtime can be performed using a variety of methods, such as inheritance, annotation, or the like.

A specific methodology of dynamic loading relates to reflection, which is commonly used by programs that need to examine or modify the runtime behavior of classes, instances, methods or applications running in the Java virtual machine. It will be appreciated that while the term reflection is used in the programming languages of Java and Python, analogous mechanism exists in other languages, such as calling a dynamically named method in JavaScript. The disclosure is equally applicable to such terms and programming languages.

One technical solution of the disclosure comprises, in addition to building an initial legacy dependency graph, also identifying situations in which the code, such as Java® code, imports and uses the reflection library. Using such detected usage enables to detect and interrogate classes or other components that implement interfaces contained within the scanned code.

When such reflections are found, one or more nodes or edges between nodes may be added which relate to that code that is invoked dynamically, for example code that implements an interface or extends a class within the invoking code. One or more edges may be added within the dependency graph from the invoking code which loads the invoked code dynamically, to the invoked code, for example between an interface and the code unit that implements it, or between a class and a class that extends it. It will be appreciated that the invoked code may comprise vulnerabilities, and/or may invoke or call further code, which may comprise vulnerabilities. Thus, the analysis makes these vulnerabilities reachable, such that a user can examine the user's code, the vulnerabilities, assess the risk, take corrective actions, or the like.

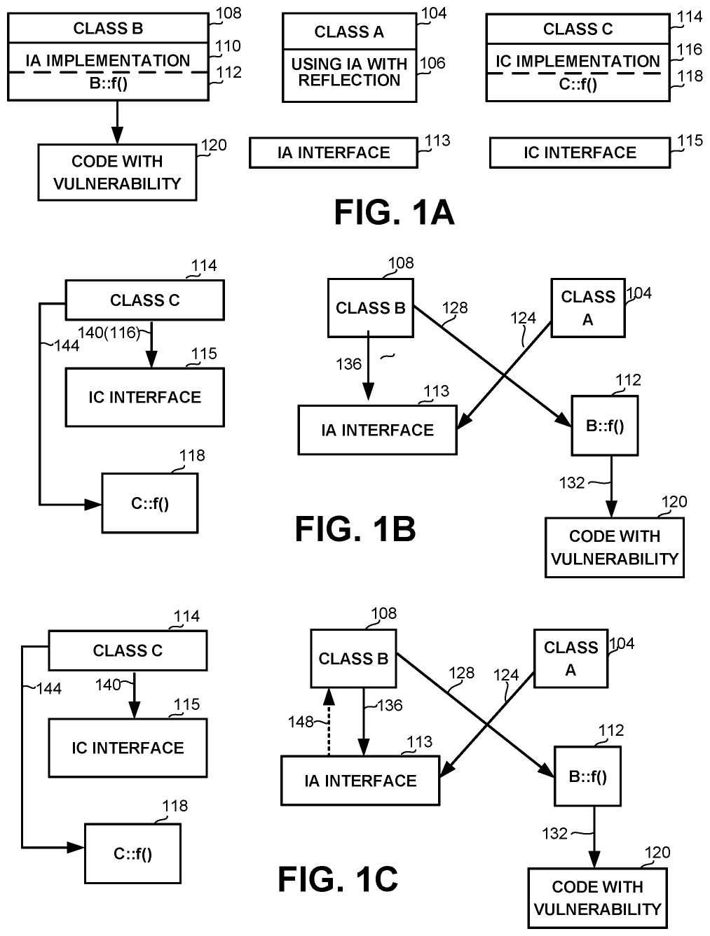

Referring now to FIG. 1A, showing a class diagram of code containing a reflection API, FIG. 1B showing a corresponding traditional dependency graph representing the situation of FIG. 1A, and FIG. 1C showing a corresponding dependency graph representing the situation of FIG. 1A, as created in accordance with some embodiments of the disclosure. FIG. 1A is class diagram of the code shown in Listing 1 below.

```
Listing 1
import java.lang.reflect.Proxy;
public class A {
  private IA getInstanceWithReflection( ) {
    return (IA) Proxy.newProxyInstance(
      IA.class.getClassLoader( ),
      new Class[ ]{IA.class},
      (proxy, method, args) −> method.invoke(proxy, args));
  }
}
public class B implements IA {
  private String name;
  public B( ) {
    this.name = “Jon”;
  }
  f( ){
    this.name = “Mike”;
  }
}
public class C implements IC {
  private int age;
  public C( ) {
    this.age = 25;
  }
  f( ){
    this. age = 50;
  }
}
```

This example thus comprises IA interface 113 and IC interface 115. The example further comprises Class A 104 which uses or references (106) IA interface 113 through reflection, Class B 108 which comprises an implementation 110 of IA interface 113, wherein the implementation comprises a function f( ) 112 that calls code with vulnerability 120, and Class C 114 which comprises an implementation 116 of IC interface 115, which further comprises a possibly different function f( ) 118. It will be appreciated that f( ) 118 can also comprise or call code with vulnerabilities, such as code 120 or another code. It will be appreciated that code 112 or code 118 may include additional code, for example open source libraries, for which vulnerability information may exist.

A traditional dependency graph, as shown in FIG. 1B, would therefore comprise edges as follows:

Edge 124 from class A 104 to IA interface 113, since class A 104 uses IA interface 113;

Edge 128 from Class B 108, to function B::f( ) 112, since Class B 108 calls B::f( ) 112;

Edge 132 from B::f( ) 112 to code with vulnerability 120, since B::f( ) 112 calls code with vulnerability 120;

Edge 136 from class B 108 to IA interface 113, since class B implements IA interface (see 110 above).

Edge 140 from Class C 114 to IC interface 115 since Class C 114 implements IC interface 115 (see 116 above); and

Edge 144 , from Class C 114 to function C::f( ) 118 since Class C 115 calls C::F( ) 118.

With this graph, assuming execution starts from Class A the only reachable component is IA interface 113. In particular, none of Class B 108, Class C 114, any implementation of IA 110, B::f( ), C::f( )and code with vulnerability 120 is statically reachable, thereby none is checked for vulnerabilities.

In accordance with the disclosure, once dynamic loading such as reflection API is detected, for example by the importation of the java.lang.reflect.Proxy library, when a first class dynamically loads and invokes methods in a second class that implements an interface of the first class, an edge may be added from the first class to the second class.

Thus, as shown in FIG. 1C, edge 148 from IA interface 113 to Class B 108 is added, since Class A 104 uses interface IA through reflection, therefore an edge is added from interface IA to all classes that implement interface IA, including Class B, which makes Class B 108, B::f( ) 112 and code with vulnerability 120 reachable. FIG. 1C thus demonstrates that code with vulnerability 120 is also reachable from Class A 104, and therefore such vulnerabilities once they become known, can be checked, sanitized or otherwise taken into account or eliminated.

One technical effect of the disclosure relates to extending the dependency graph created by static analysis using conventional technologies, to include additional reachable code that is only invoked dynamically by reflection when the code is executed. By adding dependency from the invoking code to the invoked code, wherein the invoking code is uninformed about the invoked code until runtime, additional code that was unreachable may become reachable, and can thus be checked for vulnerabilities.

Moreover, it will be appreciated that static analysis enables the analysis of programs that contain bugs, or are even incomplete or do not compile. Therefore, static analysis can be used even at early stages of the development cycle, when errors and vulnerabilities are easier to correct than at later stages.

Another technical effect of the disclosure relates to identifying code that is invoked using the reflection or introspection mechanism.

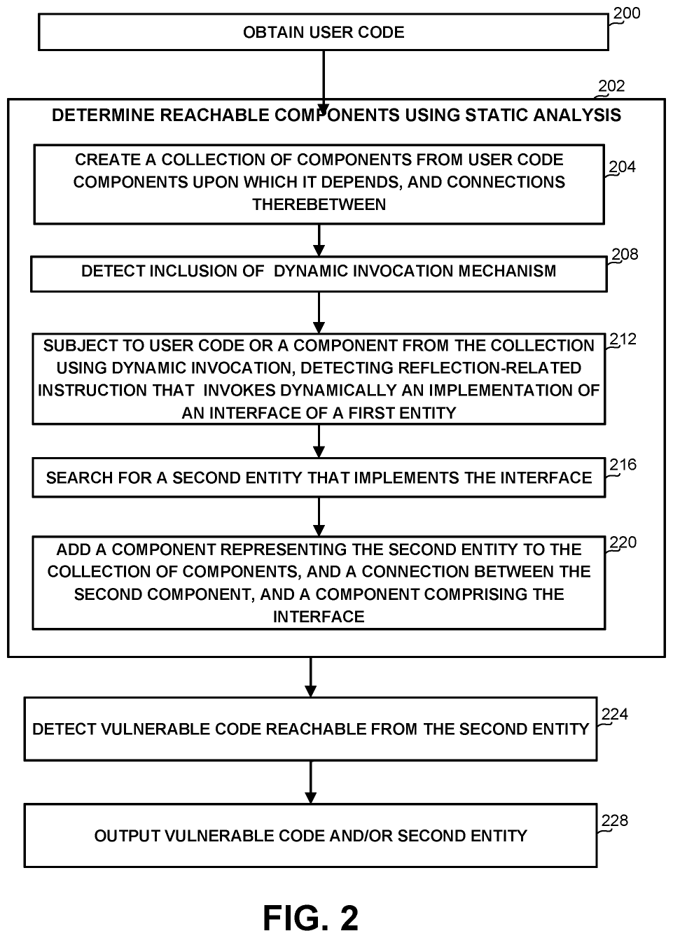

Referring now to FIG. 2, showing a flowchart of steps in a method for statically generating a dependency graph including dynamically invoked code, in accordance with some exemplary embodiments of the disclosure.

On step 200, computer code may be obtained. The code may be obtained in any manner, such as read from a file, transmitted over a communication network, typed by a programmer, being a part of a programming project developed using an Integrated Development Environment (IDE), or the like. The code may be in any programming language, such as but not limited to Python, Java, C, C++, or the like. For example, the code listed in Listing 1 above may be received.

Step 202 may comprise step 204, for determining a collection of components upon which the computer code depends, wherein at least one component of the collection of components is to be loaded dynamically by the computer code. Each of the components may be a class, a file, a method, a function, a program component, an interface, or a module. Dependency between components may refer to reachability, file dependency, a usage relationship, or the like. The collection of components and dependencies therebetween may be referred to as a dependency graph, wherein dependency between the components may be determined using any desired method, for example as described in U.S. patent application Ser. No. 16/702,834, filed Dec. 4, 2019, titled “A System and Method for Interprocedural Analysis” and assigned to the same applicant as the current application.

On step 208, the user code and the collection of components may be scanned to detect inclusion of a dynamic invocation mechanism. Dynamic invocation may relate to reflection, using dynamic code component loading, or the like. For example, in Java code, the command for importing the reflection library may be: “import java.lang.reflect.Proxy”. In Python code, the inclusion command may be “getattr” or “__subclass__”. The code may be searched by parsing with regular expressions comprising the commands above. The commands may be hardcoded or obtained dynamically when analyzing the program.

On step 212, subject to the detection of the dynamic invocation mechanism, dynamic invocation of entities that augment first entities included in the user code or in the collection of components may be detected. For example, an instruction may be detected which calls a method from the reflection library for interrogating an entity in run time for getting properties of the entity. Augmentation may relate to a class implementing an interface, a class extending another class, or the like.

For example, in Java, the invoking code may be of the form of:

```
getInstanceWithReflection( ) {
  return (SearchedInterface) Proxy.newProxyInstance(
                          SearchedInterface.class.getClassLoader( ),
                        new Class[ ]{SearchedInterface.class},
                        (proxy, method, args) −>
                        method.invoke(proxy, args));
```

Detection may include searching for the invoking command, and once found searching for the interface name. For example once the “Proxy.newProxyInstance” is found, the string following the ‘(’ character and preceding the ‘.’ character is the interface name.

On step 216, second entities that augment the first entity whose name was found on step 212, for example “SearchedInterface”, may be identified within the libraries included in the project being developed, to which the code belongs.

On step 220, a component representing each second entity that implements the interface may be added to the collection of components. A connection may then be added from the second (implementing) component to the first component comprising the interface. Such connection may be represented as adding an edge to the dependency graph described above.

On step 224, once the connections are known, vulnerabilities may be searched for using any known method. For example, if the connections are represented as a dependency graph, the dependency graph may be traversed using any known method, such as Breadth First Search (BFS), Depth First Search (DFS), or the like. For each traversed node, vulnerabilities may be searched within databases storing known vulnerabilities for libraries, or the like. Thus, the database may be searched for one or more entries associated with reachable components represented by items of the collection which are loaded dynamically and directly or indirectly comprise vulnerabilities.

On step 228, information about the detected vulnerabilities and or the components that invoke them (the second entity) may be output, for example provided to a user in a file, over a display device, transmitted over a communication channel, or the like.

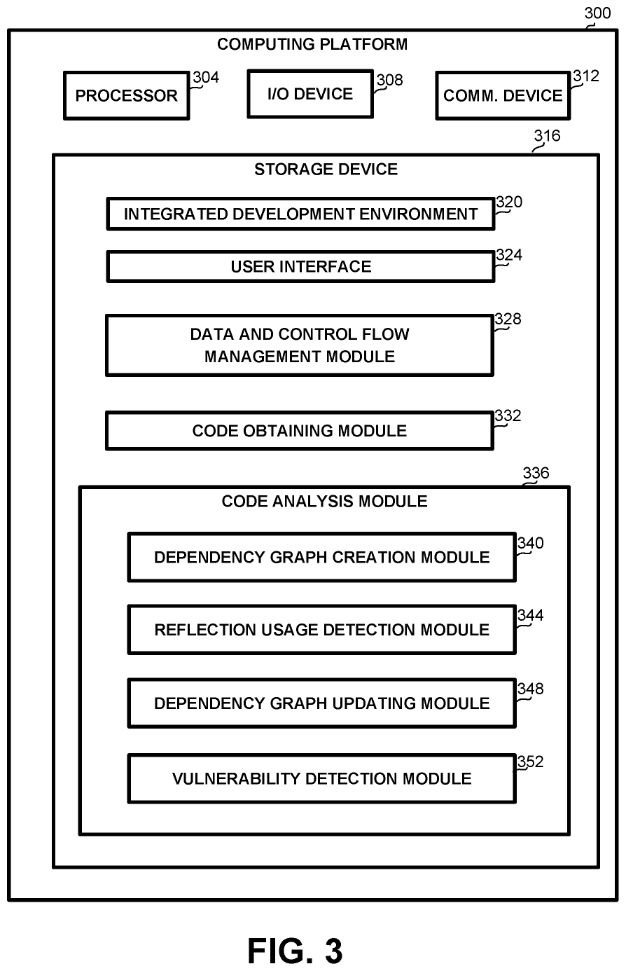

Referring now to FIG. 3 showing a block diagram of a system for statically generating a dependency graph including dynamically invoked code, in accordance with some exemplary embodiments of the disclosure.

The system may comprise one or more computing platform 300, which may be for example a computing platform used by a developer. The system may be implemented as a stand-alone system, or as part of an Integrated Development Environment (IDE) implemented for example as a plug-in, or the like.

Computing platform 300 may be performed as two or more interconnected computing platforms. For example some of the modules listed below may be performed by one computing platform, while others may be performed by a different computing platform. In some embodiments, one or more of the computing platforms may be implemented as cloud computers.

In some exemplary embodiments of the disclosed subject matter, computing platform 300 can comprise processor 304. Processor 304 may be any one or more processors such as a Central Processing Unit (CPU), a microprocessor, an electronic circuit, an Integrated Circuit (IC) or the like. Processor 304 may be utilized to perform computations required by the apparatus or any of its subcomponents.

In some exemplary embodiments of the disclosed subject matter, computing platform 300 can comprise an Input/Output (I/O) device 308 such as a display, a pointing device, a keyboard, a touch screen, or the like. I/O device 308 can be utilized to provide output to and receive input from a user. For example, I/O device 308 can display the dependency graph, the detected vulnerabilities, or the like.

Computing platform 300 may comprise a communication device 312 for communicating with other computing platforms or databases, for example computing platforms that implement some of the steps of FIG. 2, one or more databases comprising information about vulnerabilities of libraries such as open source libraries used by the code directly or indirectly, or the like.

Computing platform 300 may comprise a storage device 316. Storage device 316 may be a hard disk drive, a Flash disk, a Random Access Memory (RAM), a memory chip, or the like. In some exemplary embodiments, storage device 316 can retain program code operative to cause processor 304 to perform acts associated with any of the subcomponents of computing platform 300.

Storage device 316 can store the modules detailed below. The modules may be arranged as one or more executable files, dynamic libraries, static libraries, methods, functions, services, or the like, programmed in any programming language and under any computing environment.

Storage device 316 may store a programming development environment 320, also referred to as IDE designed for programming, compiling if required, executing and debugging program code. One or more of the modules below may be implemented as one or more components such as plug-ins for IDE 320, enabling a user to view or examine a dependency graph of the code, receive a vulnerability report. Alternatively, one or more modules may be implemented as a separate executable which may be invoked by the user, or in any other manner and frequency.

Storage device 316 may store user interface 324 for displaying results to a user or receiving from the user various aspects associated with the disclosure, such as a displaying a visual representation of the graph, displaying a tabular representation of the graph, displaying the detected vulnerabilities, or the like.

Storage device 316 can store data and control flow management module 328, for managing the control and data flow of the apparatus, such that modules are invoked at the correct order and with the required information. For example, data and control flow management module 328 can be configured to call vulnerability detection module 352 after initial graph creation module 344 and reflection usage detection module 348 have finished, and provide the generated graph.

Storage device 312 can store code obtaining module 332 for obtaining computer code from a user. The code may be received in any manner, such as read from one or more files, retrieved through a communication channel, or the like. Code obtaining module 328 can also be part of IDE 320 and thus have access to the code.

Storage device 312 can store code analysis module 336 for statically analyzing the code, and determining a dependency graph including code that is invoked dynamically, as described in association with FIG. 2 above.

Code analysis module 336 can comprise dependency graph creation module 340, for creating dependency graphs. In a non-limiting example, dependency graph creation module 340 can implement functions for creating a dependency graph from code, adding nodes and edges, or the like. Dependency graph creation module 340 may add all nodes and edges discovered using known technologies, as described above.

Code analysis module 336 can comprise reflection usage detection module 344 for detecting usage of reflection, as detailed in association with steps 208, 212 and 216 of FIG. 2 above. Module 336 may thus detect by a static analysis the usage of dynamically loaded and invoked code. Reflection usage detection module 344 can detect the action of invocation of classes implementing interfaces within the user's code, and therefrom detect also the invoked classes or other ode units, and code invoked by these classes, thus identifying further reachable code.

Code analysis module 336 can comprise dependency graph updating module 348, for updating the dependency graph created by dependency graph creation module 340, and adding additional edges and optionally additional nodes determined from the code that was realized as reachable by reflection usage detection module 344.

Code analysis module 336 can comprise vulnerability detection module 352, for detecting vulnerabilities in all reachable code, as represented by the dependency graph as initially created and updated by dependency graph updating module 348.

It is noted that the teachings of the presently disclosed subject matter are not bound by the computing platforms described with reference to FIG. 3 and the method of FIG. 2. Equivalent and/or modified functionality can be consolidated or divided in another manner and can be implemented in any appropriate combination of software with firmware and/or hardware and executed on one or more suitable devices. The steps of FIG. 2 can also be divided or consolidated in a different manner.

The system can be a standalone entity, or integrated, fully or partly, with other entities, which can be directly connected thereto or via a network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, JavaScript, NodeJs, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
obtaining user code;
using static analysis, determining from the user code a collection of components upon which the user code depends, the collection of components comprising a first component representing a first entity, wherein at least one component of the collection of components is to be loaded dynamically by the user code;
determining whether the user code or the first component from the collection of components uses dynamic invocation;
subject to the user code or the first component using dynamic invocation, adding a new connection to a second component from the collection of components, the second component representing a second entity that augments an entity reachable from the first entity; and
outputting information about the second entity.

2. The method of claim 1, wherein the new connection is between the user code and the second component.

3. The method of claim 1, wherein the new connection is between the first component and the second component.

4. The method of claim 1, wherein adding the new connection comprises:
detecting within the user code or the first component a reflection-related instruction that invokes dynamically an augmentation of the first entity;
identifying the second entity that augments the first entity;
adding the second component representing the second entity to the collection of components; and
adding a connection between the user code or the first component and the second component.

5. The method of claim 4, wherein detecting the reflection-related instruction comprises identifying instructions related to a reflection Abstract Program Interface (API).

6. The method of claim 5, wherein the instructions comprise:
an instruction for importing a reflection library; and
an instruction for calling a method or component from the reflection library for dynamically loading a component.

7. The method of claim 1, further comprising:
using information retrieved from a database, determining that at least one stored vulnerability is reachable from the second entity, thereby identifying a potential vulnerability reachable from the user code.

8. The method of claim 7, further comprising outputting the at least one stored vulnerability.

9. The method of claim 1, wherein the collection of components and connections forms a dependency graph.

10. The method of claim 1, wherein at least one component from the collection of components represents a class, a file, a method, a function, a program component, an interface, or a module.

11. The method of claim 1, wherein the at least one component of the collection of components is to be dynamically loaded for interrogating an entity in run time for getting properties of the entity.

12. The method of claim 1, wherein the second entity augmenting the first entity relates to the first entity being an interface and the second entity being an implementation of the interface, wherein the connection connects the component comprising the interface to the component comprising the implementation the interface.

13. The method of claim 1 wherein the second entity augmenting the first entity relates to the first entity being a class and the second entity being an extension of the class, and the connection connects the component comprising the extension of the class to the component comprising the class.

14. A computerized apparatus having a processor, the processor being configured to perform the steps of:
obtaining user code;
using static analysis, determining from the user code a collection of components upon which the user code depends, the collection of components comprising a first component representing a first entity, wherein at least one component of the collection of components is to be loaded dynamically by the user code;
determining whether the user code or the first component from the collection of components uses dynamic invocation;
subject to the user code or the first component using dynamic invocation, adding a new connection to a second component from the collection of components, the second component representing a second entity that augments an entity reachable from the first entity; and
outputting information about the second entity.

15. The apparatus of claim 14, wherein the new connection is between the user code and the second component or between the first component and the second component.

16. The apparatus of claim 14, wherein adding the new connection comprises:
detecting within the user code or the first component a reflection-related instruction that invokes dynamically an augmentation of the first entity;
identifying the second entity that augments the first entity;
adding the second component representing the second entity to the collection of components; and
adding a connection between the user code or the first component and the second component.

17. The apparatus of claim 16, wherein detecting the reflection-related instruction comprises identifying instructions, wherein the instructions comprise:
an instruction for importing a reflection library; and
an instruction for calling a method or component from the reflection library for dynamically loading a component.

18. The apparatus of claim 14, wherein the steps further comprise:
using information retrieved from a database, determining that at least one stored vulnerability is reachable from the second entity, thereby identifying a potential vulnerability reachable from the user code; and
outputting the at least one stored vulnerability.

19. The apparatus of claim 14, wherein the at least one component of the collection of components is to be dynamically loaded for interrogating an entity in run time for getting properties of the entity.

20. A computer program product comprising a non-transitory computer readable medium retaining program instructions, which instructions when read by a processor, cause the processor to perform:
obtaining user code;
using static analysis, determining from the user code a collection of components upon which the user code depends, the collection of components comprising a first component representing a first entity, wherein at least one component of the collection of components is to be loaded dynamically by the user code;
determining whether the user code or the first component from the collection of components uses dynamic invocation;
subject to the user code or the first component using dynamic invocation, adding a new connection to a second component from the collection of components, the second component representing a second entity that augments an entity reachable from the first entity; and
outputting information about the second entity.
